(19) United States
(12) Patent Application Publication
(10) Pub. No.: US 2009/0262137 A1
(43) Pub. Date: Oct. 22, 2009

(54) SYSTEMS AND METHODS FOR PRESENTING PREDICTION IN A BROADCAST

(76) Inventors: Jay S. Walker, Ridgefield, CT (US); Evan Walker, Ridgefield, CT (US); Russell P. Sammon, San Francisco, CA (US); Zachary T. Smith, Norwalk, CT (US); Jeffrey Y. Hayashida, San Francisco, CA (US); Renny S. Talianchich, London (GB); Gregory J. Scribner, Southbury, CT (US)

Correspondence Address: Walker Digital Management, LLC, 2 High Ridge Park, Stamford, CT, 06905, US

(21) Appl. No.: 12/350,719

(22) Filed: Jan. 8, 2009

Related U.S. Application Data
(60) Provisional application No. 61/020,254, filed on Jan. 10, 2008.

(51) Int. Cl. G09G 5/00; H04H 20/53

(52) U.S. Cl. 345/629

(57) ABSTRACT

Methods and systems are presented for presenting prediction in a broadcast. In an embodiment, the method includes receiving, by a prediction graphic generator, at least one of telemetry data, situational data, or historical data. The prediction graphic generator then determines a prediction based on at least two of the telemetry data, the situational data, or the historical data, and generates a prediction overlay based on the prediction. The prediction overlay is output to a broadcast computer, where it is combined with a live broadcast to generate an enhanced broadcast. The broadcast computer then broadcasts the enhanced broadcast.

### CROSS-REFERENCE TO RELATED APPLICATION

This application claims the benefit of U.S. Provisional Patent Application No. 61/020,254 filed Jan. 10, 2008 entitled SYSTEMS AND METHODS FOR PRESENTING PREDICTION IN A BROADCAST, which is hereby incorporated by reference herein.

### FIELD OF THE INVENTION

The present invention generally relates to systems, methods, and apparatus for determining and presenting prediction overlays during a broadcast of a live event to viewers.

Advantages and features of the invention will become apparent upon reading the contents of this document, and the nature of the invention may be more clearly understood by reference to the following detailed description of the invention, the appended claims and to the drawings attached hereto.

### BRIEF DESCRIPTION OF THE DRAWINGS

FIG. 1 illustrates a system configured to implement a process for presenting prediction in a live broadcast for a viewer according to an embodiment of the invention;

FIG. 2 is a simplified flowchart of a process for presenting prediction for a live event according to an embodiment;

FIG. 3 illustrates an example of a prediction graphic that may be used as an overlay in accordance with an embodiment;

FIG. 4 illustrates an updated prediction graphic in accordance with the embodiment of FIG. 3; and

FIGS. 5A and 5B illustrate a scenario wherein a prediction graphic is selected and activated after a play has begun.

### DETAILED DESCRIPTION OF THE INVENTION

Advantages and features of the invention will become apparent upon reading the contents of this document, and the nature of the various aspects of the invention may be more clearly understood by reference to the following detailed description of exemplary embodiments, the appended claims and to the drawings.

One reason sports fans watch athletic competition is the allure of seeing players perform spectacular feats of athletic ability. Many viewers like to marvel at players achieving seemingly impossible accomplishments. Although fans can usually recall or point out the especially spectacular plays, for instance a diving catch, there is no standard measure for how difficult or rare a play may be. One phrase commonly used by sports commentators is “the best players make it look easy,” meaning that in some instances a seemingly routine play may actually be worthy of special notice. In some instances, even plays that that are accredited may not receive the appropriate appreciation from fans. Although statistics and color commentary may be provided by sports commentators during a sports broadcast, fans have little means of discerning exactly how easy and/or difficult or how common and/or rare each type of play may be when compared to other plays that may take place in the game.

To help viewers gauge a play's difficulty, disclosed are methods and apparatus for overlaying or adding graphics to live broadcast video representing an outcome's historic frequency or a “prediction”. The prediction may be determined as the play is occurring, using historic data, situational data, and live telemetry data. For instance, when an athlete is competing or making an attempt (for example, stealing a base, hitting a pitch, catching a pass, and the like) in some embodiments a human operator may input situational data into a broadcast computer. Examples of situational data may be the names of a pitcher, baserunner, and a batter in a baseball game. The broadcast computer may then search a database to find the outcomes of all recorded instances in which that particular batter faced that particular pitcher. The computer's evaluation of the historic data may then determine how often the baseball batter has hit against that pitcher and may form a prediction of whether or not the batter will obtain a hit in this instance. Additionally, data detected by telemetry devices may factor into a prediction, such as the speed of a pitch or an average pitch speed. The determined prediction may be presented and/or reflected by a prediction graphic inserted into the broadcast of the game for viewing by fans watching the game.

In other embodiments, a prediction graphic may be displayed after an initial prediction is determined, and the accuracy of the prediction can be constantly updated based on live telemetry data being recorded at the game. Thus, the prediction or odds of an event may change based on the measurement data received from sensors at the event, and the prediction graphic being displayed for viewers may then change over the course of a play to reflect the actual difficulty or rarity of that play. For example, returning to the situation described above, the prediction graphic selected based on historic outcomes is a graphic overlay that makes the batter's bat glow bright red to show that the batter has a good chance of getting a hit. However, when a pitch tracking device determines that the pitch is a curve ball, and that it will be low and away, the batter's bat suddenly turns blue (during the pitch) to reflect that the pitch is especially hard to hit. Therefore, if the batter strikes out on that particular pitch the viewer is alerted to the fact that the pitch was extremely difficult to hit, even though the batter was expected to perform well based on the historic data. Such changes made to a prediction graphic based on telemetric data give the viewer extra insight into plays occurring in the game

In another example, during a live broadcast of a baseball game, a base runner is attempting to steal second base. When it is apparent that the player may be attempting to steal, a ghost or avatar image may be overlaid on the broadcast video to depict an estimate of how fast that player must run to successfully steal the base. Initially, the position of the avatar may be based upon a determination of the catcher's arm strength, and on the jump the runner got on the pitcher's throwing delivery movements. The position of the avatar relative to the actual player may change as the play unfolds based on the speed of the runner and on the speed of the pitch. For instance, the “ghost runner” may start out 2 or 3 steps ahead of the base runner, showing that the base runner would likely to be thrown out. However, when the pitch is registered by a field sensor as a change-up (a slower than normal pitch, allowing the runner additional running time to reach the base) the image of the base runner gets closer to the image of the avatar, which illustrates that the runner has a better chance at successfully stealing second base.

Thus, some embodiments described herein include a process for depicting an outcome prediction by adding a graphic to a live broadcast event, which may include receiving at least one of telemetry data from sensors, situational data and historical data from a database. Such a process includes determining a prediction based on at least one of, or a combination of, telemetry data, situational data and historical data, determining an overlay based on the prediction, combining the overlay with a live broadcast and then outputting and/or broadcasting the combination to viewers. In some embodiments, the method may also include updating the prediction based on telemetric data, and then updating the overlay based on the updated prediction.

Another implementation is disclosed of a process for depicting an outcome prediction by adding a graphic to a live broadcast event that includes receiving at least one of telemetry data from sensors, situational data from an operator, and historical data from a database, and creating a computer generated synthetic image of an outcome based on at least one, or a combination of, telemetry data, situational data or historical data. The synthetic image depicts a predicted condition necessary for an outcome to occur (for example, a minimum distance). This process also includes combining and outputting the computer generated synthetic image with a broadcast of the live event, and may include updating the predicted condition based on new telemetry data, and then accordingly updating the overlay based on the updated predicted condition.

The processes may also include altering an overlay based on a change in the prediction. Such processes could also include determining a change in the prediction based on a change in telemetry data, and/or determining a change in the prediction based on new telemetry data. A computer generated image could be utilized to illustrate prediction changes, and such computer generated images could be of a player, avatar or other image. In some embodiments, a human operator receives historic data, situational data, or telemetric data and determines how and/or when to use such data.

The following terms are utilized in the present disclosure:

Broadcast—Refers to the presentation of an event to a plurality of consumers who may or may not be physically present at the event. For example, content that is obtained at a live event and then transmitted from a television network to a cable provider, and subsequently to cable subscribers, is considered a “broadcast”. However, any live or recorded event that is transmitted over a network to those connected to the network can be considered a broadcast. Thus, a broadcast can be transmitted and received via radio, satellite, cellular network, other wireless device, cable, the internet, WAN, LAN, intranet, and the like.
Media—Refers to one or more types of “footage” that may be recorded at an event. For example, video footage may be obtained during a live sports event by video recording devices such as a video camera, or a digital video recorder, and the like. Similarly, audio footage may be obtained during a sports event by use of audio recording devices such as a microphone, specialized audio receiving equipment, and the like. In some embodiments, the term media may also include computer generated images and/or sounds that are created for supplementing the media footage recorded by the audio and video equipment. Once the media is obtained and/or generated by such devices, each component (content) may be sent to a broadcast mixing device and/or broadcast computer for processing and/or combining such that it becomes the broadcast content.
Broadcast Delay—Refers to the amount of time between when a live event occurs and when it is broadcast or televised. Many live events are currently broadcast after a short delay (on the order of a few seconds-live events are rarely broadcast simultaneously) so that any vulgar material that may occur or other undesirable material can be censored or deleted from the broadcast. For example, if during a televised presentation of a football game a fan runs onto the playing field holding a sign containing curse words or other defamatory and/or obscene material in front of a television camera, an operator can use the time delay to prevent the image of the fan and sign from being broadcast by, for example, switching to another camera during the broadcast delay. The methods and apparatus presented herein propose to use such a delay for the unconventional purpose of modifying live footage before it is broadcast.
Broadcast Overlay—Broadcasters often use computer generated graphics and/or audio content that can be inserted into the live footage of an event to provide the viewer with extra information. For example, sports broadcasts often overlay graphics onto live video feeds to display statistics, the score of the game, scores from other games, game clocks, player names, game information, and the like. Graphics that appear often throughout the game, such as the score or a game clock are usually placed in an inconspicuous position on the display, such as near the bottom right corner of a display screen. These types of displays are referred to as “bugs”. Other graphics may be placed in more prominent places within the display, such as statistic boxes that may appear towards the center of the screen during “down time” (which may be defined as a portion of an event where no action of interest occurs, for example, an event that occurs between plays such as when players switch sides during a tennis match). In some cases, graphics are integrated into the action, such as the yellow first down line marker that appears on the display of the field during a football game. For the purposes of the present disclosure, Broadcast Overlays are used to display a prediction determined by a Prediction Graphic Generator (which is described in detail below). It should be noted that although graphic overlays are a primary focus, audio overlays may be used as well, such as synthetic crowd noise, fake or fabricated explosion sounds, music, and the like.
Dynamic Predictions/Updated Predictions—Predictions and Prediction Graphics that have the potential to change throughout a play of a live event based on updated information. For example, an initial prediction may be determined and output using a Prediction Graphic (for example, an overlay may make a baseball player's bat appear blue to indicate that his chances of getting a hit are poor). Next, while the pitch is being delivered, cameras, radar guns and other sensors may track the direction and speed of the pitched ball to generate information that can be used to determine how difficult the pitch will be to hit. Continuing with the example outlined above, a slow, hanging curveball may be detected and therefore a new prediction may be determined. As a result, a change in the displayed Prediction Graphic may appear to indicate a dramatic increase in the player's chances of getting a hit (based on the new information received about the pitch). The result may be that a player's bat changes from blue to bright red during the pitch, which indicates the increased probability of a hit. It should be noted that, in order to emphasize Dynamic Predictions and exciting plays, slow motion effects may be applied to live footage of an event. Information regarding live, slow motion footage is described in commonly owned U.S. patent application Ser. No. 12/270,455, entitled “Methods and Systems for Broadcasting Modified Live Media”, which is incorporated by reference herein.
Historical/Outcome Frequency Data—One type of data that is factored into the determination of a prediction is information regarding outcomes that occurred in the past, such as past game data. For example, a prediction may be based on how frequently a particular outcome has occurred in the past during similar events involving the same or similar players. Such outcomes may be associated with a team, with a player, or with a group of players, and may also be filtered based on situational data (described below). Examples of historical data may include such data as a the number of wins and losses at a certain point in a season, or historical data that is gathered and associated with a particular sport, such as a number of hits and/or a number of strikeouts in baseball, or a number of passes and/or a number of touchdown passes thrown in football, and the like.
Prediction—As used herein, a prediction may represent the determination of a probable outcome based on a combination of historic, situational and telemetric data. For example, a prediction may be made during a football game regarding a place kicker's chances of successfully making a field goal based on the kicker's previous attempts at similar kicking distances and the current weather conditions. Predictions may change (referred to as a “Dynamic Prediction”, and explained further above) throughout the course of a play, for example, if a strong cross-wind intensifies while a football is traveling in the air towards the end zone uprights after being kicked by a place kicker in a football game.
Prediction Graphic—The present methods and apparatus may include the use of broadcast overlay graphics (or audio) to display prediction information. For example, when a batter steps up to the plate during a baseball game, an overlay may change the color of his bat to indicate his chances of getting a hit. The color red may indicate a high potential for a hit, whereas a blue bat may indicate lower chances of a hit. Such graphics may also change throughout the duration of a play to indicate fluctuations in the predicted outcome (the “Dynamic Predictions” explained above). In some embodiments, predictions may also be presented using Prediction Graphics comprising a computer generated simulation of a successful event or outcome. Such a simulation may then be overlaid onto live footage of the event so that the viewer can compare the simulation with the action that is occurring in the live event. For example, a player attempting to steal a base may be running in the same base path as an overlaid “ghost runner” image or simulation of a runner that will successfully steal the base, in order to gauge the prospects of the actual base runner successfully stealing the base (more examples are provided below).
Situational Data—specific information regarding a situation within a game that may be used as a factor when determining probability information. Situational Data (information) may be stored and/or associated with historical and/or outcome frequency data, and may be generally used to focus the type of historical or statistical data used to calculate a probability or a prediction. For example, an operator may input the identity of a pitcher and a hitter so that the only type of historical data referenced by the system are the outcomes of instances where a particular pitcher pitched to a particular hitter in a specific ballpark. Similarly, data regarding the climate, time of day or year, venue, and the like, may also be classified as situational data.
Telemetric Data—Refers to data recorded from a remote location, and transmitted to a central location (for example, telemetric data may include measurements of distance, speed, position, and direction). For example, the measurement of the speed of a baseball pitch taken by a RADAR gun and sent to a remote display or computer would be considered Telemetric Data. Similarly, a Laser Range finder that determines and transmits the distance of a player from home plate would be considered telemetric data. Telemetric data may also be received from one or more objects related to a sporting event. For example, a baseball player's bat may be fitted with a wireless accelerometer and transmit information relating to the player's bat speed and swing plane. In another example, sensors within a football helmet may transmit that player's running speed as well as data relating to a collision during a game.

1. System Components

Traditional recording devices such as video cameras, digital video cameras, microphones, digital recorders, and the like may be used to transmit live video and audio feeds for a television broadcast. Examples of such recording devices include the Canon GL1 DV Camcorder manufactured by Canon Incorporated and the SHURE MC50B/MC51B manufactured by Shure Incorporated, or the HDC-1000 manufactured by the Sony Corporation. The recording device may feature a high quality zoom lens such as the DigiSuper 100AF manufactured by Canon Incorporated.

The present apparatus and methods contemplate calculating probabilities and predictions of the outcomes for a game or individual plays within a game, and using graphics to display this information. In order to make a prediction, real time telemetric data may be collected and transmitted to a broadcast computer. This data, possibly combined with a database of static measurements and images, may then be used by a computer to render three dimensional images of the live event. Examples of hardware that may be used to collect and transmit telemetric data include Radio Detection and Ranging devices (RADAR), Laser Range-Finders (LIDAR), Sound Navigation and Ranging devices (SONAR), GPS transmitters (for example, Global Positioning System transmitters), RFID Sensors (for example, Radio Frequency transmitters), cameras, and Motion sensors and/or detectors. Details of such devices are provided immediately below.

Radio Detection and Ranging devices (RADAR) include a transmitter to emit radio waves and a receiver (or detector) to receive the radio waves that bounce back from objects. The returning waves are detected and used by the device to form measures of range, altitude, direction and speed of moving objects, or to detect fixed objects.

Laser Range-Finders (LIDAR) are similar to RADAR, and LIDAR devices use an emitter to emit a concentrated beam of light, and a portion of the concentrated light bounces off of an object and returns to a light detector associated with the device. A LIDAR device is used to determine range, speed, shape, altitude, direction, and the like of an object.

Sound Navigation and Ranging devices (SONAR) are similar to LIDAR and RADAR, but utilize sound waves to obtain various measurements. In particular, an emitter emits sound waves that bounce off objects and a portion of the sound waves return to a detector of the device. A SONAR device is also used to determine range, speed, shape, altitude (or depth), direction, and the like of an object.

GPS transmitters may be worn by players and other participants (for example, coaches, referees, umpires, and the like in order to identify where the player is on the playing area, such as a field and/or court), and provide position data.

RFID Sensors may be worn by players and other participants (such as coaches, referees, umpires, and the like in order to identify which player(s) are currently on and off of the field and where). An example of such a system is described in U.S. Pat. No. 6,567,038 to Granot et al., which is incorporated herein by reference.

Cameras capturing images may be used to detect measurements and to provide data for use by a computer to build three-dimensional models of objects by calculating triangulation. One example of such a system is described in U.S. Pat. No. 6,081,273 to Weng et al., which is incorporated herein by reference.

Motion sensors and/or detectors and relative position sensors, such as multiple-axis gyroscopes, accelerometers, magnetometers, inclinometers or integrated sensors such as inertial measurement units (for example, one or more accelerometers may be paired with a transmitting device that could be embedded in a player's uniform) may be used in some embodiments. Such sensors and/or detectors may transmit telemetry data of one or more body parts of a player during a play, such as the arm or leg of the player. An accelerometer may be particularly useful at measuring sudden acceleration and/or deceleration, or the power generated by an impact, such as a baseball base runner slamming into a catcher at home plate, or a football running back being tackled by a linebacker.

An anemometer such as a windmill anemometer, a hot wire anemometer, a laser Doppler anemometer, and the like, may be used to measure wind speed conditions during a ballgame.

In some embodiments, data acquisition hardware may be needed to direct the output from one or more telemetry devices to a computer system capable of evaluating the acquired telemetric data. For example, a data acquisition card such as National Instrument's PCIe-6259 is capable of directing digital telemetry data into a computer system via a PCIe bus. Similarly, DATAQ Instrument's DI-730EN makes use of a Wi-Fi network in order to transmit telemetry data from one or more devices to a computer system for processing.

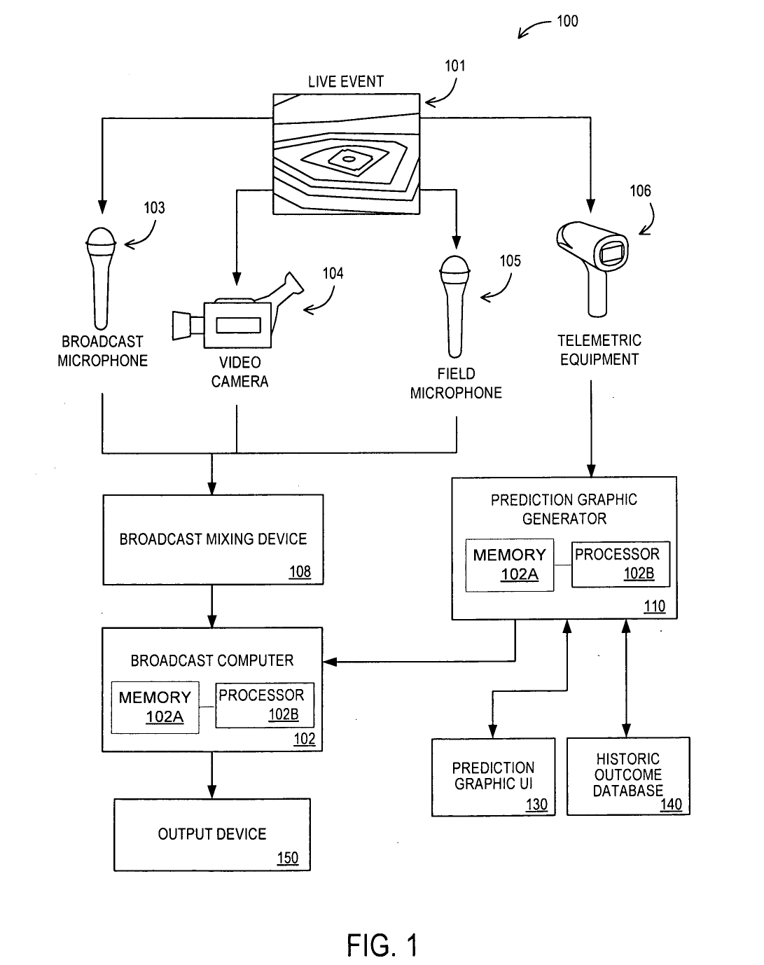

FIG. 1 is an illustrative system 100 configured to carry out the present methods. A Broadcast Computer 102 may receive data input from any of the types of recording equipment mentioned above, which devices are being used to record a live event 101. In particular, FIG. 1 shows a broadcast microphone 103, video camera 104, field microphone 105 and a telemetric device 106 all being used to record the live event 101 taking place on a playing field within a stadium in view of fans of the teams that are playing there. The various input data received from the various recording equipment during the live event may be: (i) stored in a memory 102A and/or (ii) processed by an internal processor 102B within Broadcast Computer 102. The memory 102A may be operatively coupled to the processor 102B as shown, and may include a computer program of instructions configured to direct the processor to function according to the processes described herein. Broadcast Computer 102 may also contain various software applications and/or hardware that allow input video and audio to be edited into a linear, televised program before being transmitted to an output device.

The Broadcast Computer 102 may also include or be connected to other editing hardware such as a broadcast mixing device 108. The broadcast mixing device 108 allows a broadcast editor, which may be a person having experience in a particular sport, or may be a device, to (i) combine separate audio feeds into one audio output, (ii) combine audio and video output, (iii) mix graphics (prediction graphics specifically) into the video output, (iv) allow switching between video and audio inputs, and the like. An example of such technology may be found in the Indigo AV Mixer manufactured by Grass Valle, which device features video up- and down conversion, the ability to mix in high-resolution PC graphics from any DVI-I source, advanced audio mixing, and automated device playback and control via industry-standard connections.

Broadcast Computer 102 may also be connected to a Prediction Graphic Generator 110, which may be used to generate prediction graphics based on data inputs that include situational data, historical data and telemetry data. Prediction Graphic Generator 110 may comprise hardware such as a memory 110A and a processor 110B, and/or may include software capable of (i) using input data to make a prediction, (ii) determining or creating an appropriate graphic based on the prediction, and (iii) combining or overlaying the graphic onto the broadcast video output. In order to perform such functions, either Broadcast Computer 102 or Prediction Graphic Generator 110 may include software such as the Inscriber® G-Series™ systems manufactured by Harris Corporation.

The Prediction Graphic Generator 110 may also comprise software applications and/or hardware capable of creating Computer Generated Imagery (CGI) and incorporating it into a broadcast. In such embodiments, CGI may be used to create a prediction graphic, for instance a virtual representation of a player or game object. CGI software may be able to construct a 3-Dimensional image of an actual player, object or entire scene by using a combination of actual video footage, live or recorded telemetry data and stored data. An example of CGI software suitable for use to generate such 3D images is the Electric Image Animation System 3D Rendering and Animation Software for Macintosh and Windows, manufactured by El Technology, LLC.

The Prediction Graphic Generator 110 may also be connected to a variety of other devices, such as Telemetry Device 106. The Telemetry Device 106 may be any of the devices listed above (such as a motion sensor and/or an accelerometer) capable of recording measurements taken at a live event and transmitting these measurements to the Prediction Graphic Generator 110. Similarly, the Prediction Graphic Generator 110 may receive situational data from a Prediction Graphic User Interface (UI) 130, allowing an operator to interface with the Prediction Graphic Generator 110. The operator may provide situational data input such as the names of players, the weather conditions, and the like, via the Prediction Graphic UI 130. In some embodiments, known or previously inputted situational data may be automatically loaded into the Prediction Graphic UI and may require confirmation from an operator. In another embodiment, Prediction Graphic UI 130 may allow an operator to interact with the Prediction Graphic generator for the purposes of creating and/or selecting and/or configuring prediction graphics, confirming or previewing the use of a prediction graphic, and the like. Confirmation or previewing of a prediction graphic may be performed by an operator during a broadcast delay. The Prediction Graphic UI 130 may be comprised of various input devices such as a touch screen, mouse, keyboard, microphone, and the like. In addition, the Prediction Graphic Generator 110 may be communicating with a Historic Outcome Database 140 that stores historic data used to determine probability information and predictions.

There are also a variety of other devices relevant to broadcast production that may or may not be present in the described system. For example, devices currently used in broadcast production include video tape players and recorders (VTRs), video servers and virtual recorders, digital video disk players (DVD players), digital video effects (DVE) players, audio mixers, audio sources (for example, CD's and DAT's), and video switchers. Any or all of these devices may or may not be included in the present system and could be connected to the Broadcast Computer 102.

In some embodiments, broadcast information (for example, video and audio signals output via radio, satellite, cable, internet, and the like) may be transmitted to an output device controlled by the broadcaster and/or by the viewer. Such output devices allow the broadcaster and/or viewer to watch the broadcast live event, and examples of such devices may include a CRT display, an LCD display, a plasma screen, an analog television set, a high-definition television set, a cell phone, a personal digital assistant (PDA), a portable game device (for example, a Sony PSP®) a laptop, a desktop computer, a set of speakers, and the like.

2. Processes

Some embodiments of processes will now be described. It should be understood that the steps involved in any exemplary process may be executed in any order practicable, that some steps may be optional, and that other steps and methods are also contemplated.

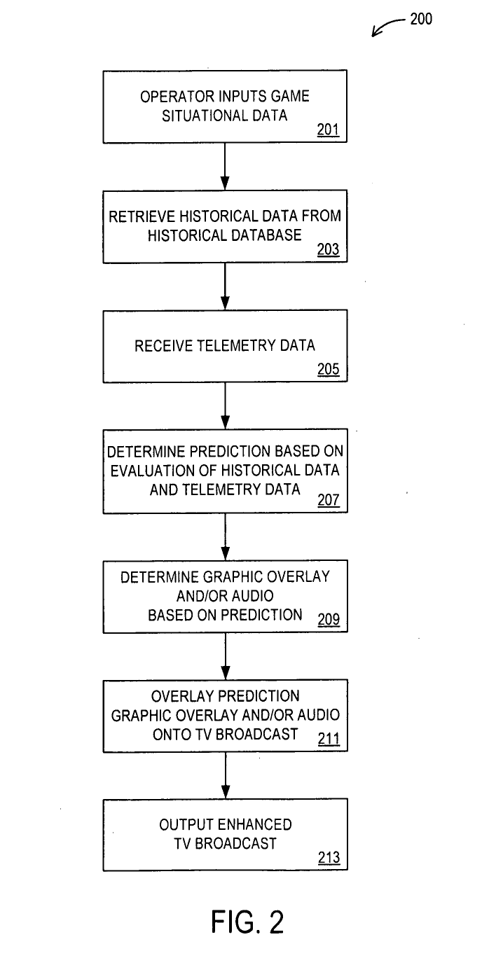

FIG. 2 illustrates an exemplary process 200 for generating an enhanced broadcast that may be realized through use of the system components described above. In step 201, an operator inputs situational data associated with a prediction. For example, if the prediction graphic will ultimately depict whether or not a soccer player will successfully score a goal when taking a penalty kick, the process of step 201 may require an operator to input information such as the name of the goal keeper, the name of the kicker, the venue, and the current weather conditions. The operator may use a Prediction Graphic UI (described above with regard to FIG. 1) to manually input situation data. In some embodiments, instead of an operator manually inputting situational data, software may be utilized (either in combination with the Prediction Graphic UI or on a Prediction Graphic Generator) to generate the situational input data.

At step 203, the process involves retrieving a set of historical outcomes (historical data) from an Historical Database based on the input situation. Next, the method includes receiving Telemetry Data 205 from one or more telemetry devices, and then determining a prediction 207 based on an evaluation of the historical data and the telemetry data. Immediately below is an example of a process that includes steps 203, 205 and 207 (in the context of a baseball game), and others are contemplated, as discussed below.

In some embodiments, Outcome Frequencies may be stored in the Historical Database and used to determine a prediction. In such an embodiment, a database entry may resemble the following table appearing below, wherein the Pitcher Name and Batter Name entries represent input situational data and the Pitch Speed entries represent received telemetry data.

Input Data

| Pitcher | Batter | Pitch |
|---|---|---|
| Name | Name | Speed |
| Roger | Manny | X > 93 |
| Clemens | Ramirez | MPH |

Output Data

| # of Historic | # of | Outcome | |
|---|---|---|---|
| Occurrences | Hits | Frequency | Prediction? |
| 100 | 40 | 40% | HIT |

Using the data in the tables shown above, a determination is made that Manny Ramirez has gotten a hit off of Roger Clemens 40% of the time in such situations. Since this is a relatively high percentage of hits (when considering that a typical batting average is below 0.300, meaning that a hitter gets a hit less than 30% of the time), the “Prediction?” output may therefore be that Manny Ramirez has a good chance of getting a hit (“HIT” in the table) in this at bat.

After a prediction has been determined, in step 209 the Prediction Graphic Generator determines an appropriate Prediction Graphic Overlay to overlay on the broadcast video. In some embodiments, a Prediction Graphic Generator stores a set of possible graphics that are associated with specific predictions. In other embodiments, an appropriate graphic may be created or configured by a human operator using the Prediction Graphic UI, or may be generated by a software application operating with the Prediction Graphic Generator. For example, determining the graphic/audio 209 may include determining that a positive baseball hit prediction can be represented by a prediction graphic overlay that makes Manny Ramirez's bat glow a red color.

After an appropriate graphic has been chosen, the Prediction Graphic Generator may output an indication to the Broadcast Computer to combine or overlay 211 the prediction graphic with the image on the TV Broadcast Feed. This may be accomplished by using an audio video mixer such as the Indigo AV Mixer manufactured by Grass Valley, or by using a software system such as the Inscriber® G-Series™ systems manufactured by Harris Corporation. The enhanced broadcast is then output 213.

The present apparatus, systems and methods are contemplated as a feature that may be used for both live and recorded broadcast events. However, in some embodiments, it may be difficult or even impossible to determine a prediction and to apply a prediction graphic to a live event before it is broadcast. Therefore, a delay between the broadcast of an event and the actual occurrence of the event may be utilized to apply the prediction graphic. Currently, networks and broadcasters utilize about a seven second delay for live broadcasts so that editors have enough time to cut out vulgar material and/or undesirable material before it is broadcast, and to have time to correct technical problems with little or no disruption in the broadcast from the viewer's perspective. For the purposes of this disclosure, a similar delay, or in some embodiments a longer delay, may be used to allow time for the processes to be conducted and applied to the delayed, live broadcast. (U.S. patent application Ser. No. 12/270,455, which is commonly owned, includes more information regarding broadcast delays and applying modifications to a delayed broadcast.)

In some embodiments, a method for depicting probability information by adding a graphic to a live broadcast event includes receiving at least one of telemetry data from sensors, situational data from an operator and historical data from a database. The process includes determining a prediction based on at least one of or a combination of telemetry, situational, or historical data, and then determining an overlay based on a prediction. The method also includes combining the overlay with a live broadcast to generate an enhanced broadcast, updating the prediction based on updated telemetry data, and then providing an update or providing an updated prediction overlay based on the updated prediction. It should be understood that a combination of situational data, telemetric data and historic data may be used in order to determine a probability for, or a prediction of, an outcome of an athletic event.

2.1 Situational Data

The Prediction Graphic Generator generally receives situational data from a “Prediction Graphic Operator” (which may be referred to simply as an “operator”) via an interface located on a Prediction Graphic UI. In some embodiments, an operator is constantly inputting and updating situational information, regardless of whether or not it is used to determine a prediction. Such a process ensures that all necessary situational data is available to make a prediction should a “random event” occur (random events are discussed below in more detail). In some embodiments, an operator only inputs situational data necessary to make a prediction for a “predetermined event” (and such predetermined events are discussed below in more detail). In some other embodiments, situational data may be preloaded into a Prediction Graphic UI and may require an operator's confirmation. For example, prior to coverage of an Indianapolis Colt's football game, the name Peyton Manning may be preloaded at the quarterback position, saving an operator valuable time during each play. An operator may simply be required to select a wide receiver from a pull-down menu to indicate Peyton Manning's target receiver during a pass play. Should Peyton Manning prematurely leave the game, the operator may override the default and select a new default quarterback on the Prediction Graphic UI.

In some embodiments, situational data may comprise one or more “events.” Events define a particular situation within an athletic competition for which the Prediction Graphic Generator is predicting an outcome. In many embodiments, the event itself may factor into the determination of what is being predicted. For example, if the event is an at bat during a baseball game, then the Prediction Graphic Generator may interpret that information as a command to predict whether or not the batter will get a hit. Similarly, if the event is a stolen base attempt during the baseball game, the Prediction Graphic Generator may determine a prediction of whether the runner will be thrown out or make it to the next base safely. Such situational events can be classified into two different types of events—predetermined events and random events.

Predetermined events may be defined as events that occur at predetermined times or stages within a competition or game. Predetermined events may be subject to predictions because they regularly occur as part of the game's structure as set forth in the rules of that game. A predetermined event may also be the result of another event, such as a free kick in a soccer game that was awarded because of a foul charged against a defending team player. Such an occurrence may afford the operator time to input information, configure graphics, confirm graphic settings, and the like. These types of predictions can therefore be strategically applied to make the broadcast more interesting throughout the broadcast of the game (as opposed to appearing on every single play.) Examples of regularly occurring events include, but are not limited to a down in football, a free throw in basketball, a field goal attempt in football, a stroke taken on a golf course during a tournament, and a pitch during an at bat of a baseball game.

In contrast, random events may be defined as events that occur randomly during a competition and therefore cannot be anticipated by an operator. In such cases, the steps of prediction determination and prediction graphic output may therefore necessarily be an automatic occurrence and may require less input from a (human) operator. For example, unexpected events such as a base runner stealing a base when there are two outs in a close game, or a shot taken during a soccer or hockey game by a player who ordinarily does not shoot or who ordinarily does not play offense, and the like may occur from time to time. In another example, a hit occurs during an at bat and the hitter is running towards first base while his teammate is rounding third. In such a situation, the predicted outcome could be based on whether or not the player is safe at home, whether or not a fielder catches the batted ball, whether or not the hit will be a home run or result in more than a single, and the like.

In some embodiments, operators prepare predictions for random events in case a random event occurs. For example, every time a runner reaches first base during a baseball game, a prediction is made and a graphic is prepared in case that runner decides to attempt a steal. Thus, if a runner who ordinarily would not attempt to steal does try to steal second base, then the prediction graphic can be quickly and easily applied.

In some embodiments, prediction graphics can be configured and applied to the broadcast video during a broadcast delay. For example, once an operator detects the occurrence of a random event, a prediction graphic is configured and applied to the delayed broadcast. In some cases, broadcast delays may also be used for predetermined events as well.

In some embodiments, situational data may comprise one or more “subjects.” Subjects define the individual player(s) involved in an athletic event, and may be associated with Historic Data stored in the Historic Database (Historic Data and the Historic Database is described below in further detail).

Subjects may be broken into two different categories: general subjects and specific subjects. A general subject may be defined as a group of subjects that fall into a particular category. For example, pitchers on the National League teams of Major League Baseball, the pitchers in the National League East Division, the pitchers of the New York Mets, and the like. Specific subjects may be defined as a specific player or group of players involved in an event. For example, specific subjects could include baseball player Derek Jeter of the New York Yankees, or the entire Chicago Bears football team.

In some embodiments, situational data may comprise information about an event location, such as venue data. Examples include:
The location of a race track where a NASCAR™ race is being held, and characteristics of turns at that track.
The stadium in which a football game is being played.
The golf course on which a PGA golf tournament is being held, and the characteristics of the particular holes being played.
Dimensions of a baseball park (for example, different ball parks may have different dimensions, such as distance from home plate to the outfield wall and the shape of the wall)
Playing surface conditions (for example, natural turf or artificial turf, any recent rain or snow, wet pavement, wet or muddy field surface, ice temperature for hockey games, green and fairway conditions for golf)
Crowd information (for example, number of spectators, demographics, loyalties, noise level, stadium capacity, and the like)

In some embodiments, situational data may comprise environmental information. It should be noted that situational data may be entered manually by an operator, or determined automatically based on telemetric data. Examples of environmental information include the temperature, humidity and precipitation (for example, rain, snow, sleet), the altitude (for example, it has been demonstrated that a curve ball pitch is less effective at high altitude because of the thinner air), weather patterns (for example, sunny vs. cloudy, the angle of sun in the sky relative to a player's viewing direction), and the time of day (for example, day games vs. night games, duration of game).

In some embodiments, an operator may be a person who is watching a live sporting event. While watching the event, the operator may make determinations about individual situations and manually input this information via the Prediction Graphic User Interface. In some other embodiments, the operator may be a software program configured to utilize input data to monitor a live event. For example, a software program may be stored in and operate on the Prediction Graphic Generator, which monitors inputs from recording equipment in order to determine situational data. For example, facial recognition software may be used to monitor video feeds and recognize participating players. An example of such facial recognition software can be found in “FastAccess” software manufactured by Sensible Vision, Inc. In some embodiments, voice recognition software could be used to monitor audio commentary of a sports event and interpret participating players based on that data. An example of voice recognition software is Dragon Naturally Speaking 9® offered for sale by Nuance Communications, Inc.

2.2 Telemetry Data

It is contemplated that telemetry data could be used as a factor in determining a prediction and to generate a prediction graphic. Telemetry data may be received from one or more remote measurement devices used at a live event. For examples of telemetry devices suitable for such use, see the descriptions above concerning Telemetry and Recording Equipment. Telemetry equipment may be used to take measurements of speeds, distances, and the like of events or factors involving one or more athletes, for example, that may play an important role in a play's result and/or a play's difficulty. The output of the telemetry equipment may be transmitted directly to a Prediction Graphic Generator, or may be manually input by an operator via a Prediction Graphic UI. For example, a RADAR gun, such as the “JK-RG” Gun manufactured by the JUGS Company, may be used to record and transmit the speed of an object, such as the speed of a baseball that is pitched to a batter, or the speed of a tennis ball when a player serves the tennis ball to begin a point during a game. Thus, when predicting the chances of a baseball pitcher striking out a batter, the speed of a pitched baseball as it travels towards the plate may be measured. Similarly, such a device could be used when predicting the chances of a tennis player winning a point (the speed of a tennis ball serve may be measured), when predicting the chances of a player reaching a base safely (the speed of a base runner in the base path may be measured), or when predicting the chances of success of a football field goal attempt (the speed of a football after it has been kicked by the kicker could be measured as it travels towards the uprights).

In some embodiments, devices such as a Laser Range Finder (for example, the Bushnell Pinseeker 1500™ manufactured by the Bushnell Outdoor Products Company) may be used to record and transmit the distance of an object from a specific location, such as a golf ball from the cup. Such a device could be used, for example, when predicting the chances of a baseball fielder throwing a runner out at home plate (a distance may be determined from where a fielder catches the ball to home plate), when predicting the chances of a golfer landing a ball on the green (a distance may be determined from the ball to the green), when predicting the chances of a soccer player scoring a goal (the distance of the player from the goal may be measure), or when predicting the winner of a race (the distance of runners from the finish line may be determined).

In some embodiments, a device such as a camera feeding footage to a computer with 3D imaging and/or tracking software may be configured to record and transmit the position or location of an object and/or of a player. In addition, small transmitters attached to the object and/or to the players may be detected by sensors covering a predetermined area. For example, data from such devices could be used when predicting the chances of a quarterback making a completion (the position of his receivers and or the defenders may be determined), or when predicting the chances of a baseball player stretching a single into a double (the position of the ball on the field may be determined).

In some embodiments, a device such as an anemometer may be used to determine weather conditions that may have an effect on a play's outcome. For example, an anemometer could be used to determine the wind speed and the wind direction, which could then be factored into a prediction of the chances of a golfer hitting an accurate shot, or when predicting whether or not a football kicker will be able to kick a field goal.

An inertial measurement unit (IMU) may be used in some embodiments, and may be composed of one or more accelerometers, gyroscopes and magnetometers to record and transmit the location or relative movement of an object. For example, a magnetometer within an IMU located on (attached to) a soccer player would be able to detect that the orientation of a player's body has become completely inverted with respect to the field surface during a play involving a bicycle kick by that player. In another example, a multi-axis gyroscope embedded within a baseball thrown by major league baseball pitcher Tim Wakefield may be able to detect only a half-revolution from the time the ball leaves his hand at the pitcher's mound to home plate, serving as an indication that Tim Wakefield's knuckleball is working well and is probably unhittable. Thus, such an indicator (a number of revolutions detected on a knuckleball) may be used to predict the effectiveness of the pitch against a batter.

Telemetry data may be used to measure the position, velocity, or acceleration of a player during a sports contest. For example, predictions could be based on measurements of the movements of a soccer player as he runs around a field (for example, using RFID sensors), on the movements of a baseball player as he runs the bases (for example, using sensors embedded in the base path), or of the movements of a tennis player reacting to a serve (for example, using a high speed video camera). In addition, telemetry data may be used to measure the position, velocity, or acceleration of sporting equipment. For example, measurements could be obtained concerning the movement of soccer ball around a soccer field (for example, using RFID sensors), the movement of baseball bat as batter swings for a pitch (for example, using IMU), the movement of golf ball as it is hit by a club (for example, using a Doppler radar), and/or the movement of a racing car around a racetrack (for example, using a combination of GPS and IMU devices). Telemetry data may also be used to measure information about playing conditions, such as current weather conditions (such as humidity, wind, temperature), current lighting conditions (shadows, clouds), current sound conditions (such as crowd noise), current playing field conditions (for example, oil on the racetrack, mud on the football field, and/or roughed up ice on the surface of a hockey rink).

In some embodiments, the telemetry data used to make a prediction may be an average measurement taken over the course of a game. For example, instead of using a reading or measurement taken from the play in question, average or historic telemetry data may be used to determine a prediction. For example, the average speed of the pitches thrown by a pitcher over the course of a baseball game, the average throwing speed of a catcher when attempting to throw out a stealing runner at second base, the average serving speed of a tennis ball by a tennis player, the average running speed of a baseball player when he is a base runner, and/or the average wind speed in a football stadium during a field goal attempt.

In some other embodiments, telemetry data may constitute a range of measurements. For example, a number of telemetry data points may be taken over a period of time, and based on these data points a range of measurement may be inferred. For example, a minimum and maximum wind speed over a time period of five minutes may constitute the lower and upper measurements of a range. In another example, an average and standard deviation may be calculated for wind speed during the previous five minutes of a baseball game. The average wind speed minus the standard deviation may be reported as a lower measurement of a range, while the average wind speed plus the standard deviation may be reported as the upper measurement of the range.

In some instances, readings taken during the occurrence of a play may be factored into a prediction. For instance, a prediction may be made before or during an event, but the prediction may change or a graphic may be dynamically adjusted based on telemetry measurements taken during the event or over the course of an event. Examples of such readings include, but are not limited to, the speed or position of a baseball pitch during an at bat, the distance of a baseball fielder from a base, the trajectory of a batted baseball or a football pass, and/or the position of a hockey goalie relative to the trajectory of a hockey puck shot toward the goal net by a player from the opposing team.

2.3 Historic Data/Historic Outcome Frequency Data

Historic outcome data (sometimes referred to as “Historic Data” or “Outcome Frequency” herein) may be used as a factor in determining a prediction. Such information may be stored in a Historic Database accessible by the Prediction Graphic Generator. Based on received situational and/or telemetry information, the Prediction Graphic Generator may be configured to retrieve appropriate historic data from a Historic Database to be used to determine a prediction graphic. Is should be understood that any information concerning historic outcomes that may aid the Prediction Graphic Generator in determining a player's ability to perform a particular action may be stored in a historic database. For example, based on input situational data, the Prediction Graphic Generator may search the historic database for similar or related past events. Based on an evaluation of the frequency of certain outcomes occurring in these events, the Prediction Graphic Generator determines a prediction, or at least an indication of a trend, showing what is likely to occur in the present event.

Historic outcome data that may used to determine a probability or likelihood of a future outcome occurring may include indications of past outcomes, such as a number of steals achieved by a baseball player, a number of hits obtained by a baseball player, a number of goals scored by a hockey team, a number of field goals made by a football kicker, and/or a number of sacks recorded by a defensive football player. Historic outcome data stored in the historic database may also include a number of attempts and or unsuccessful outcomes, such as a number of steals achieved coupled with the number of stolen bases attempted by a player, a number of hits obtained by a player coupled with a number of outs made or at bats for that player, a number of goals scored by a team and the number of shots taken by a team, a number of field goals made by a kicker and the total number of field goals attempted by that kicker, and/or a number of sacks recorded by a defensive football player and the number of downs played by that player.

In some embodiments, historic outcome data may be associated with situational data. For example, database entries may associate data with a type of event, such as a number of baseball steals obtained DURING A STOLEN BASE ATTEMPT, and/or a number of strike outs DURING AN AT BAT. In addition, database entries may associate data with a particular subject, such as a number of hits obtained BY ALEX RODRIGUEZ, a number of sacks obtained BY THE BEARS' Defense. Also, database entries may associate data with a particular subject relative to a condition, such as a number of field goals obtained by football kicker David Akers IN THE RAIN, or the number of aces served by tennis player Andy Roddick ON CLAY COURTS. In some other embodiments, historic outcome information may be associated with telemetry data. For example, database entries may associate stored data with specific telemetry information, such as statistics regarding a number of hits obtained by a player WHEN the pitcher is throwing fastballs above 90 MPH, or statistics regarding a number of football field goals scored by a player WHEN the field goal attempt is taken from outside or beyond the 18 yard line.

Historic data can be stored in a central database that is connected to a Prediction Graphic Generator via a network, or a locally stored database in communication with the Prediction Graphic Generator. In addition, specific historic data associated with a subject and/or event may be found by applying a condition to a defined subject (for example, a player) and/or event. Such conditions limit the applicable statistics or historic outcomes that are used to determine a prediction. For example, conditions may restrict based on a time limitation, a geographic position, a weather condition, and the like. In a specific example, a defined subject is baseball player Derek Jeter and an associated condition may be “home games”. In this situation, only statistics or historic outcomes occurring during home games (at Yankee Stadium) would be retrieved for use in a prediction. In another example, a defined subject is football kicker Adam Vinateri and an associated condition may be “rain”. According to such a condition, only statistics or historic outcomes occurring during games played in the rain would be retrieved for use in a prediction. In yet another example, a defined subject is football quarterback Brett Favre and an associated condition may be “2004 season”. According to such a condition, only statistics or historic outcomes that occurred during the 2004 season would be retrieved.

Historic databases may be periodically updated so that stored information and/or statistics are accurate. For example, databases may be updated every day, or databases may be updated after each game, or databases may be updated after each event occurs

2.4 Determining a Prediction

Information stored in the historic database may be segregated such that data can be filtered based on situational and/or telemetric data, for example. The Prediction Graphic Generator may use situational and telemetric data to filter a search of the historic database in order to find specific historic outcome data (such as Outcome Frequency). For example, a number of attempts and a corresponding number of outcomes produced in a subset of those attempts may be retrieved. In some embodiments, situational data is used to determine the historic outcome data that is retrieved from the historic database. Situational event information may be used to limit the search to a particular type of historic outcome information. For example, if the operator defines the event as a “field goal attempt”, then the Prediction Graphic Generator will search for “field goal attempt outcomes” such as successful tries and/or missed attempts.

In some embodiments, situational information may limit the search to historic outcome information related to particular players, teams or conditions. For example, an operator may define one or more situational subjects, such as football player “Rob Bironas”, and based on this information, the Prediction Graphic Generator will limit the search to historic outcomes associated with Rob Bironas. In another example, an operator may define one or more situational conditions, such as “Lambeau Field”, and based on this information, the Prediction Graphic Generator will limit the search to historic outcomes associated with Lambeau Field.

In some embodiments, received telemetry data may be used to determine historic outcome data that is retrieved from the historic database. For example, telemetry data such as a distance between the kicker and the football goalpost uprights, may be incorporated into a search in the historic database. Based on this information, the Prediction Graphic Generator will limit the search to field goal attempt outcomes occurring at the same or at a similar distance. In another example, telemetry data such as the direction and or speed of the wind may be incorporated into a search in the historic database so that the Prediction Graphic Generator will limit the search to field goal attempt outcomes occurring during the same or similar wind speeds and directions.

In some embodiments, a combination of situational and telemetric data may be used to determine historic outcome data that is retrieved from the historic database. For example, the temperature and wind direction (telemetry data) at Fenway Park (situational data) may be used to limit historic outcome information that is retrieved in association with a specific pitcher-hitter matchup (situational data). In another example, the average cornering speed of a race car and the current position of a NASCAR driver in a race, along with a racetrack name, can be used to filter and retrieve historic outcome information that may be used to generate a prediction graphic.

Once Historic Outcome Data has been retrieved from the Historic Database, the data may be evaluated and used to determine a prediction of whether or not an outcome will occur. In some embodiments, a historical average or “Outcome Frequency” may be determined. For example, a number of outcomes may be determined along with a number of attempts, and an Outcome Frequency may be determined by finding a historical average. For instance, the number of outcomes is divided by the number of attempts to determine the Outcome Frequency (which corresponds to the percentage of total attempts in which a specific outcome occurred). That is:

Number of Outcomes/Number of Attempts=Outcome Frequency

In some embodiments, Outcome Frequency may be as simple as the number of successful outcomes. For example, an outcome frequency may simply be defined as how many times an outcome has occurred in the past. For instance, if a batter has obtained twenty (20) hits, then the Outcome Frequency is “20”.

A prediction may be determined by comparing the Outcome Frequency to a threshold amount. For example, an Outcome Frequency of at least 60% warrants a favorable prediction, whereas an Outcome Frequency of less than 40% warrants an unfavorable prediction. In another example, an Outcome Frequency of “more than 20” warrants a favorable prediction, whereas an Outcome Frequency of “less than 20” warrants an unfavorable prediction. In a specific example, an outcome frequency of 15% is determined with regards to predicting a specific hitter hitting a 9th-inning, game-winning homerun off of a specific pitcher. When compared to the 2% outcome frequency for the rest of the hitter's team in the same situation, 15% is thus determined to be relatively high.

In some embodiments, a prediction can be inferred from the determined Outcome Frequency, and thus determining an Outcome Frequency may be sufficient for the purposes of generating a Prediction Graphic based on the Outcome Frequency. In other embodiments, a more descriptive prediction may be determined that provides an explanation for the data.

In some embodiments, a prediction may comprise a determination which forecasts whether or not a particular outcome will occur, or which of a plurality of potential outcomes will occur. For example, based on the Outcome Frequency, it may be determined that an outcome is likely, or that the outcome is unlikely. Similarly, a prediction may comprise a simple “yes or no” answer to a query of whether or not an outcome will occur. Examples of such queries include:
Is this football play going to be a pass or a run?
Is the base runner stealing on the next pitch, or not?
Will the base runner be called out, or safe?
Will the NASCAR driver crash, or not?
Will the NASCAR driver run out of gas, or not?
What type of baseball pitch will be thrown? (selected from the set of pitch types that the pitcher can throw, such as a slider, sinker, fastball, split-finger fastball, or curveball)

In some embodiments, a prediction may comprise one of a plurality of tiered predictions. For example, ranges of outcome frequencies may be determined with associated predictions. In an embodiment, a range of from 40%-60% may determine a prediction of “unlikely”, the range 60%-80% may determine a prediction of “likely”, and the 80%-90% may determine a prediction of “highly likely”.

Different types of predictions may include different considerations. For example, the odds of an event occurring (for example, on a scale of 0% to 100% certainty), a selection of a player from a list (for example, which soccer player is most likely to score a goal?), and may comprise an either/or decision such as the player will be either “out” or “safe”.

### 2.4.1 EXAMPLES

### Example #1

In a particular example in the context of a professional football game, Green Bay Packers kicker Mason Crosby is about to attempt a 25-yard field goal. An operator inputs the type of event for which a Prediction Graphic is going to be generated (in this case, a field goal attempt from less than 40 yards away from the goalposts) and the following information may be used to retrieve Outcome Frequency information:

Data Received by the Prediction Graphic Generator

Telemetry Data

| | | |
|---|---|---|
| Situational Data | Wind | Wind |

| Kicker? | Venue? | Direction? | Speed? |
|---|---|---|---|
| M. Crosby | Lambeau | Kicking Into | 10-15 MPH |
| | Field | | |

As described above, situational data may have been provided by an operator, and telemetry data may have been received from telemetry devices at the live event. Using this data, the Prediction Graphic Generator searches the Historic Database for field goal attempt information associated with Mason Crosby, and in particular, for field goal attempts of less than 40 yards taken at Lambeau Field. Data may also be filtered based on received telemetry data by limiting retrieved data to Mason Crosby field goal attempts at Lambeau Field when kicking into a 10-15 MPH wind. The retrieved data may be similar to the example provided below:

Historic Data for Mason Crosby When Distance is Less Than 40 Yards

| | Successful | Outcome |
|---|---|---|
| Attempts | Attempts | Frequency |
| 8 | 7 | 87.5% |

Once the Outcome Frequency has been determined, a prediction can be made based on how often the outcome has occurred in the past. For example, the following table may be used to determine the prediction:

| Outcome Frequency | Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

Various implementations may use different types of data to determine a prediction. The following two examples utilized different situational data to illustrate the same determination made above.

### Example #2

In Example 2, which is similar to Example 1 above, the venue has not been specified, so that the historical data indicates that the Outcome Frequency is now 58% (instead of 87.5% as calculated above).

Data Received by the Prediction Graphic Generator

| | | Wind | Wind |
|---|---|---|---|
| Kicker | Venue | Direction | Speed |
| M. Crosby | — | Kicking | 10-15 MPH |
| | | Into | |

Historic Data For Mason Crosby For
All Attempts of Less Than 40 Yards

| Successful | | Outcome |
|---|---|---|
| Attempts | Tries | Frequency |
| 22 | 38 | 58% |

| Outcome Frequency | Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

Referring to the Prediction table immediately above, the Output Frequency of 58% results in a prediction of “somewhat unlikely”, which is very different than the prediction of “very likely” found for Example 1. Thus, a different prediction graphic would be generated.

### Example #3

In this example, historical data for the kicker Mason Crosby from the 2004-2006 season is obtained, which results in successful attempts of 35 out of 49 tries of field goals from less than 40 yards under similar conditions, for an Outcome Frequency of 73%. As shown in the prediction table below, this Outcome Frequency corresponds to a prediction of “Likely” with regard to whether or not the kicker will successfully kick the field goal.

Data Received by the Prediction Graphic Generator

| | | Wind | Wind |
|---|---|---|---|
| Kicker | Season | Direction | Speed |
| M. Crosby | 2004-2006 | Kicking | 10-15 MPH |
| | | Into | |

Historic Data For Mason Crosby For Attempts of Less Than 40 Yards

| Successful | | Outcome |
|---|---|---|
| Attempts | Tries | Frequency |
| 35 | 48 | 73% |

| Outcome Frequency | Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

In some cases, there may not be enough historical data available relating to a particular situation. For example, the system may be asked to make a prediction about how professional football quarterback Vince Young will perform in the rain. However, because Mr. Young is a rookie quarterback (which means it is his first year playing in the National Football League), there may be no data concerning his play in the rain during his professional career. Thus, there is no historical data available for this particular situation. In order to solve this sort of problem, the system may make one or more assumptions, or perform groupings of historical data based on characteristics of the player or situation. For example, the system might assume that Vince Young's performance in the rain will degrade by the same percentage as any other rookie quarterback's performance has in the past. Or the system might assume that Vince Young's performance in the rain as a professional may degrade by the same amount as it did during college. For example, a prediction about how Vince Young (a rookie professional quarterback) will perform in the rain may be determined by extrapolation based on information about how other rookie quarterbacks performed in the rain, or by using data concerning how Vince Young performed during college football games in the rain (if his college football performance data is available, and includes data concerning games played in the rain). Using a change factor may facilitate this sort of prediction.

2.5 Predictions Based on Telemetry Data

In some embodiments, conditions necessary for an outcome to occur may be predicted based on high speed telemetry data collection. In such an embodiment, positions, speeds, distances and the like may be recorded and put into predetermined formulas to make performance predictions. For example, at a NASCAR event, a prediction may be made regarding whether or not a collision will occur involving a race car and a stationary wall. To make such a collision prediction, the speed of the race car, the rate of deceleration (if applicable), the direction of travel and the distance of the race car from a wall may all be used to calculate whether or not the race car will collide with the wall. Other similar examples follow. For example, when a baseball batter hits a fly ball to the outfield, telemetry devices may record information such as the ball's trajectory and the speed of the ball, which measurements may be used to predict when and where the ball will land. This information may be compared to the position, speed, and error percentage of a baseball outfielder running towards the predicted landing spot of the baseball. Based on this information, a prediction could be made concerning whether or not the outfielder will make the catch for an out. In another example, when a baseball base runner is attempting to steal second base, his running speed and distance from second base may be used to calculate when he will reach second base. This information may be compared with the speed of the pitch, and/or the speed of the catcher's throw to second base in order to make a prediction of whether or not the base runner will safely make it to second base.

In some embodiments, predictions made based on telemetry data may be compared with historical data in order to make a final prediction. For example, in the above example regarding a baseball base runner attempting to steal second base, the runner's speed and distance may be compared to an average time it takes a catcher to throw the ball to second base. In particular, a Prediction Graphic Generator may retrieve historical data showing that it takes a pitcher and catcher an average of 3.5 seconds from the delivery of the ball towards home plate of a pitch to ultimately getting the ball from the catcher to second base. Once the runner's speed and his distance from second base is determined, a prediction can be made of whether the base runner will be safe based on a forecast of whether or not the base runner will reach second base in time (before or after 3.5 seconds from the start of the pitch).

In some embodiments, a prediction may forecast based on one or more necessary conditions (for example, a running speed, a position, a minimum distance, and the like) for an outcome to occur. For example, again using the stealing base runner example from above, the Prediction Graphic Generator may determine that the base runner must reach second base in less than 3.5 seconds in order to be called safe. Based on the value “3.5 seconds” and on the base runner's recorded speed (either the current speed or a historic speed), a minimum starting distance from second base may be determined and compared with the runner's current position or lead off position from first base. The predicted minimum distance represents how close an object traveling at the recorded speed must be to second base in order to arrive in less than 3.5 seconds. In yet another illustration using the stealing base runner example, a minimum speed may be determined rather than a minimum distance. For example, based on the runner's recorded distance from second base, a minimum running speed may be calculated. The minimum speed represents how fast the base runner must run over the recorded distance in order to arrive at second base in less than 3.5 seconds.

2.7 Determining an Appropriate Overlay

After determining an Outcome Frequency or a prediction, a broadcast overlay or prediction overlay is determined by the Prediction Graphic Generator. The broadcast overlay (also known as a prediction overlay or a Prediction Graphic) is an indication to the viewer of the broadcast of the determined prediction, and will be incorporated into the broadcast video of an event. In some embodiments, a prediction overlay may be a literal representation of a prediction. For example, a text box displaying “Derek Jeter has a 60% chance of getting a hit against Pedro Martinez” may be overlaid on the broadcast for viewing by fans watching the game. Another example concerns broadcasting overlays during a Green Bay Packers football game. In this example, a prediction is made that the Green Bay Packers will throw a pass because the situation (third down and ten yards to go for a first down) calls for such a play. Thus, the prediction overlay may be a scrolling ticker at the top of the screen that appears to display target receiver predictions. After the snap of the football which starts the play, and as the play develops, it is determined that the quarterback Brett Favre will throw the ball, and the ticker may read, “Packers WR target predictions: D. Driver-45%, J. Jones-28%, G. Jennings-27%”. Such a ticker display may be constantly updated based on factors that are occurring as the play develops, such as double coverage of a particular receiver and the proximity of a receiver to a defensive player.

In some embodiments, a prediction overlay may be a symbolic representation of a prediction. For example, the color of the prediction overlay applied to a batter's bat may indicate the batter's chances of obtaining a hit. In another example, the position of a synthetic baseball runner (or avatar runner) along a baseline relative to the actual base runner may indicate the actual base runner's chances of making it to the next base safely. Such a synthetic runner may be used to indicate a predicted minimum start distance necessary to steal a base, for example, or may be used to indicate a real-time predicted running position that a base runner must be in so that he can safely reach the next base. In yet another example, the color of a soccer ball may indicate the chances of a player scoring a goal on a free kick.

Prediction Graphics may be picked from a plurality of preconfigured prediction overlays. For example, a library of possible graphic overlays may be stored and selected depending upon the type of prediction. In a particular example in the context of a baseball game, three possible Prediction Graphics may be used for an at bat. Each graphic corresponds to an overlay that makes the batter's bat look blue, orange or red, wherein the blue color means the player is not likely to get a hit, the orange color means the player is likely to get a hit, and the red color means that the player is likely to get a hit for extra bases. Once the prediction has been determined, a corresponding graphic is selected, for example, if the player has a high Outcome Frequency, then the red bat overlay may be selected.

In another example, three different types of prediction graphics may be available. For example, a synthetic bat, a synthetic image of a base runner, and a synthetic smoke trail emanating from behind the video of a baseball. Depending upon the event or outcome being predicted, an appropriate graphic is selected. For example, if the prediction is whether or not a batter will get a hit, the synthetic bat graphic is used. If the prediction is whether or not a base runner will be safe, the synthetic runner is used. If the prediction is whether or not a fielder will throw a player out, the smoke trail is used. In another example in the context of a football game, a standard text box may be displayed before every field goal attempt such as “There is a x % chance that the kick will be good” wherein x % is a determined Outcome Frequency.

In some embodiments, a prediction may be indicated by a stored audio overlay instead of a graphic overlay. For example, synthetic crowd noise may be output to indicate a prediction, such as during a penalty kick in a soccer match, the chance that the home teams' goalkeeper will block the shot may be indicated by the volume of synthetic crowd noise.

Prediction Graphics may be automatically selected by a Prediction Graphics Generator based on a set of predefined rules, and may not require any affirmative input from an operator in order to be displayed. For example, during a baseball game having a tied score, every batter automatically has a prediction graphic of a “glowing” bat to depict their likelihood of hitting a homerun. As in previous embodiments, the color of the overlay may change to another color depending on the predicted likelihood of a hitter hitting a homerun.

In some embodiments, the Prediction Graphic may be a representation of factors necessary for an outcome to occur. As explained above, a prediction of a condition such as a distance or a speed may be determined based on telemetry data. In such embodiments, prediction graphics may represent this information rather than predictions of whether or not an outcome will occur. For example, if the minimum distance from a base is determined for a base runner to be safe, this may be displayed using a Prediction Graphic, or the Prediction Graphic may be a computer generated base runner running in the base path within the minimum distance. In another example, if the minimum distance from the position where a ball is predicted to land is determined, this may be displayed using a Prediction Graphic as a computer generated fielder running to the predicted landing point within the minimum distance. In yet another example, if the necessary rate of deceleration for a car to avoid a collision is determined, this may be displayed using a Prediction Graphic that shows a car slowing at the determined rate of deceleration.

In many embodiments, dynamic predictions and prediction graphics will be used, thus an initially selected graphic may change during a play, for example. These changes may be a modification of the initial prediction graphic (for example, the prediction graphic changes color, the position of a computer generated base runner is altered, etc.). In other embodiments, multiple prediction graphics may be used over the course of one event (for example, a pitcher who is likely to strike out a batter may have a glowing glove, however, if a bad pitch is detected then such a detection may cause the batter's bat to glow instead) as explained above in the detailed discussion regarding prediction changes. For example, an overlay may depict a batter's bat as blue to represent the prediction that he will not get a hit, but if during the pitch the prediction changes, a new overlay of a red bat may replace the blue bat. In another example, if an Outcome Frequency is displayed in a text box, and the Outcome Frequency changes based on telemetry data gathered during an event, the displayed Outcome Frequency may change during the broadcast of that event.

2.8 Combining an Overlay with a Broadcast

After an appropriate graphic overlay has been chosen, the Prediction Graphic Generator may send an indication to the Broadcast Computer to combine the prediction graphic overlay with the live broadcast video. An audio/video mixer such as the Indigo AV Mixer manufactured by Grass Valley may be used, or a software system such as the Inscriber® G-Series™ systems manufactured by Harris Corporation could be utilized. In addition, there are a variety of other devices relevant to broadcast production that may or may not be present in a broadcast system suitable for providing output including such overlays. For example, devices currently used in broadcast production include video tape players and recorders (VTRs), video servers and virtual recorders, digital video disk players (DVDs), digital video effects (DVE), audio mixers, audio sources (for example, CD's and DAT's), and video switchers. Any of these devices may or may not be included in the present system, and may be used to aid in the process of combining an overlay with a broadcast.

2.9 Updating a Prediction Based on Telemetry Data

After a Prediction has been determined and a Prediction Graphic has been chosen and output, a change in telemetry data may occur that could cause an updated prediction to be generated. In some embodiments, an initial or partial prediction may be determined using situational or historical data, and then a final prediction may be made by incorporating the telemetry data. Alternatively, an initial prediction may be made based on initial telemetry data and then a revised prediction may be made based on updated telemetry data received during the course of a play.

Telemetry data may be associated with standard changes that factor into the prediction, such as a standard change associated with collected data that could be applied to the Outcome Frequency or some other figure used to determine a prediction (see “Update Example 2” below). For example, an Outcome Frequency for predicting whether a baseball batter will obtain a hit during a particular at-bat is determined to be 80%. But if a pitch is thrown by the baseball pitcher with a speed above 95 miles per hour (MPH) at any time during that at-bat, then the determined prediction or odds of a hit are lowered (because a 95 MPH pitch is especially hard to hit).

In some embodiments, after a prediction has been determined, a standard change may be applied to the prediction. For example, a prediction has been determined that a baseball player will be thrown out at second base while attempting to steal if the pitcher throws a fastball. But if the pitch is determined to be a curveball with a speed of less than 60 MPH, the prediction changes to reflect that the player should make it to second base safely (because the pitch is slow and is more difficult for the baseball catcher to catch and then throw down to second base in time to get the runner out).

In some embodiments, updating a prediction may include determining a new prediction, wherein the new prediction is calculated as a raw value rather than as a change from a previous prediction. For example, an updated prediction may be calculated using the same function as an initial prediction, but now the updated prediction includes updated telemetry data. In an embodiment, telemetry data may be used to calculate a change to be factored into the prediction. For example, the speed of every pitch in a baseball game is entered into a formula to calculate a change to be applied to the Outcome Frequency. In a specific example, a formula may be used wherein the speed of every pitch is multiplied by 0.1, as follows:

(MPH*0.1)−(Outcome Frequency)=Final Outcome Frequency

Accordingly, updated predictions may be based on updated telemetry readings such as a change in running speed of a player, a change in environmental conditions (such as wind speed, wind direction, oil spilled on a racetrack, and the like). An updated prediction could also be based on the beginning of a new portion of a chain of events, such as the initial prediction of a baseball runner scoring from second base being based on the throwing speed and accuracy of an outfielder fielding the ball, and a further updated prediction based on the speed and accuracy of a throw from a cut-off man (for example, the shortstop) to home plate.

In some embodiments, an updated prediction may be based on data (or a reading) taken from a secondary factor. For example, an initial prediction is made based on the speed and direction of a shot taken by a soccer player, and then an updated prediction is based on the movements of the soccer goal keeper and/or the position of that the goal keeper from the ball.

In some embodiments, an initial prediction may be made based on situational, historic and/or telemetry data and then may change based on updated telemetry data and/or on a new telemetry reading. In one example, a previous prediction is updated based on new information that is received. In a second example, a new prediction is made. During some sports events, for example, telemetry data used to make an initial prediction may change, thus making it necessary to determine a new prediction. In one example, a wind speed is used to make a prediction of whether or not a golfer will land his golf ball on the green, and just before the golfer begins her swing the wind stops, which requires a new prediction to be determined.

In another example, the running speed for a baseball base runner is determined and is used to make a prediction of whether or not that runner will make it safely to second base on an attempted steal, but as the base runner is running towards second base, he stumbles and consequently slows down, which changes the telemetry information used to make the prediction, thus requiring a new prediction to be made.

### 2.9.1 Example Processes Used to Update a Prediction Based on Telemetry Data

### Update Example #1

The following is an example of how a Prediction Generator could provide an updated prediction for a field goal attempt by the football player Mason Crosby from 35 yards away from the goalposts. Step 1 below illustrates how an Outcome Frequency is determined, which is based on situational data (in this case, the player's name, M. Crosby, and Distance ranges of field goal attempts). The Outcome Frequency is determined to be 80% based on selected situational data (entry 137).

Step 2 below illustrates a table that includes entries for Outcome Frequency Change based on telemetry data (in this case, the wind speed and direction, where wind is blowing in from the left sideline at 26 MPH). The Outcome Frequency is determined to be negatively impacted by 15% when crosswinds between 21-30 MPH are present. Accordingly, the initially determined Outcome Frequency of 80% is adjusted to 65% once the wind is factored in.

Step 3 below illustrates how the final predicted Outcome Frequency percentage of 65% affects the prediction, which is “Somewhat Unlikely” in this case.

Lastly, Step 4 below shows how updated telemetry data could be a factor in updating the prediction. In this case, during the field goal attempt the wind shifts direction and is at the kicker's back, which results in an Updated Outcome Frequency Change, and which also results in an Updated Prediction to “Highly Likely”.

### Step #1

| | | Distance (in | Successful | | Outcome |
|---|---|---|---|---|---|
| Entry # | Kicker | yards) | Tries | Attempts | Frequency |
| 136 | M. Crosby | 31-33 | 7 | 10 | 70% |
| 137 | M. Crosby | 34-36 | 4 | 5 | 80% |
| 138 | M. Crosby | 37-39 | 5 | 10 | 50% |
| 139 | M. Crosby | 40-42 | 3 | 5 | 60% |

### Step #2

| Wind Direction | Wind Speed | Outcome Frequency Change |
|---|---|---|
| At Face | 1-10 | — |
| At Face | 11-20 | −5% |
| At Face | 21-30 | −10% |
| At Back | 1-10 | — |
| At Back | 11-20 | +5% |
| At Back | 21-30 | +10% |
| Left or Right | 1-10 | −5% |
| Left or Right | 11-20 | −10% |
| Left or Right | 21-30 | −15% |

### Step #3

| Final Outcome Frequency | Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

### Step #4

| Updated | Updated | Updated |
|---|---|---|
| Wind Direction | Wind Speed | Outcome Frequency Change |
| At Face | 1-10 | — |
| At Face | 11-20 | −5% |
| At Face | 21-30 | −10% |
| At Back | 1-10 | — |
| At Back | 11-20 | +5% |
| At Back | 21-30 | +10% |
| Left or Right | 1-10 | −5% |
| Left or Right | 11-20 | −10% |
| Left or Right | 21-30 | −15% |

| Updated Final Outcome Frequency | Updated Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

The above example illustrates why it is important to continually receive updated readings from telemetry devices so that the new data (or readings) may be used to update a previously determined prediction. In the above situation of Update Example #1, the initial prediction was that the football kicker Mason Crosby has a “Somewhat Unlikely” chance of successfully kicking a field goal from that distance in those wind conditions. However, as the play is taking place, the wind shifted direction from the side to the rear of the kicker, as shown, and in this case the shift in direction increases the Final Outcome Frequency, which results in a change in the Prediction. In summary, the initial wind speed and direction data negatively impacted the prediction of the kicker being successful so that the initial prediction was a 65% chance for success (“Somewhat Likely”). However, when the wind changed to a more favorable direction, the updated prediction became a 90% chance for success (“Highly Likely”). In some embodiments, such a change in prediction may affect the output overlay, as discussed below.

### Update Example #2

The following is an example of how a Prediction Generator might provide an updated prediction for a field goal attempt from 35 yards away from the goalposts for the football kicker Mason Crosby. The process may include a first step of determining an initial prediction based on situational, historic, and telemetry data. Next, a second step may be utilized that includes determining an UPDATED prediction based on UPDATED telemetry data. (In the example illustrated by the tables below, the wind has completely died down.)

### Step 1

Data Received by the Prediction Graphic Generator

| | | | Wind | Wind |
|---|---|---|---|---|
| Hitter | Season | Distance | Direction | Speed |
| M. Crosby | 2004-2006 | 33-37 | Kicking | 10-15 MPH |
| | | | Into | |

Retrieved Historic Data

| Successful | | Outcome |
|---|---|---|
| Attempts | Tries | Frequency |
| 30 | 40 | 75% |

Prediction Generation

| Outcome Frequency | Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

### Step 2

Data Received by the Prediction Graphic Generator

| | | | UPDATED | UPDATED |
|---|---|---|---|---|
| | | | Wind | Wind |
| Kicker | Season | Distance | Direction | Speed |
| M. Crosby | 2004-2006 | 33-37 | — | — |

UPDATED Retrieved Historic Data

| UPDATED | | UPDATED |
|---|---|---|
| Successful | UPDATED | Outcome |
| Attempts | Tries | Frequency |
| 24 | 25 | 96% |

UPDATED Prediction Generation

| UPDATED Outcome Frequency | UPDATED Prediction |
|---|---|
| 90%-100% | Highly Likely |
| 80%-89.99% | Very Likely |
| 70%-79.99% | Likely |
| 50%-69.99% | Somewhat Unlikely |
| 30%-49.99% | Unlikely |
| 0%-29.99% | Highly Unlikely |

In the example illustrated immediately above, the updated wind speed and direction causes the Prediction Graphic Generator to produce a new and/or updated prediction. Step 1 represents a prediction made based on the wind speed and/or direction before the play starts. But then in Step 2 an updated prediction is made based on the wind speed and/or direction immediately after the start of the play (for example, when the football teams are lining up for the attempt and the ball is being snapped to the holder). In this example, the change in Telemetry data (the wind died down to become a non-factor) causes the prediction to change from “Likely” to “Highly Likely”.

2.10 Updating the Overlay Based on the Updated Prediction

Once an updated prediction has been determined, the Prediction Graphic should be updated. For example, an output prediction graphic may indicate an initial prediction that a baseball base runner will make it safely to the next base during a play. However, updated telemetry data shows the runner is tiring and is slowing down, thus a new prediction determines that the runner will not beat the throw from an outfielder to the third baseman. The steps and embodiments explained above may be used to determine an appropriate overlay to represent the updated prediction. For example, if an initial overlay depicted flames shooting out of the base runner's shoes (indicating that he is fast and would make it to third base safely), then the updated overlay may be blocks of ice overlaid onto the base runner's shoes (indicating he has slowed and will most likely be thrown out).

In some embodiments, an animation may be utilized to gradually present the shift or change in the overlays due to the updated prediction. Using the above example, the flames overlaid on the base runner's shoes may die down gradually, and then smoke, and finally the ice graphics may gradually form around the base runners' shoes and then progress up his legs.

In some embodiments, an updated overlay may simply be one of a subset of overlays from which the current overlay was chosen. For example, if the initial prediction graphic was chosen from a set of colors that may overlaid onto a baseball player's bat, then the updated prediction graphic would be chosen from a set of colors that may be overlaid onto a baseball player's bat.

In some embodiments, the updated overlay may be a prediction graphic that is different from the type used for the initial prediction. For example, an initial prediction graphic comprising a “comet trail” emanating from the back of a soccer ball that has just been kicked indicates a shot on goal that has a high velocity. However, if it is determined (for example, using 3D cameras or RFID sensors) that the soccer goal keeper is in good position to make a save and prevent the soccer ball from entering the goal, the comet trial may disappear, and a new graphic may be used to indicate the goal keeper's chances of making the save. But in some embodiments the initial prediction graphic (in this case, the comet trail) may not disappear.

In one embodiment, a sports broadcast may be paused while updated prediction information is overlaid onscreen. This pause may allow announcers or commentators to describe the revised prediction and comment on how a play is unfolding. Alternatively, or in addition, the prediction graphic may be overlaid onto a slow-motion version of a broadcast (for example, onto a slow motion instant replay), to thereby provide additional suspense for viewers and to allow the announcers to provide commentary as an event unfolds.

In one embodiment, the slow motion version of a televised event may be the first televised version of that event (for example, not an instant replay). This may create additional suspense for the viewer since the viewer does not know what the outcome of the event will be. Details concerning how to create a slow-motion version of a broadcast of a live event can be found in commonly owned U.S. application Ser. No. 12/270,455, entitled “Methods and Systems for Broadcasting Modified Live Media”.

### 2.10.1 Examples of Updated Prediction Graphics

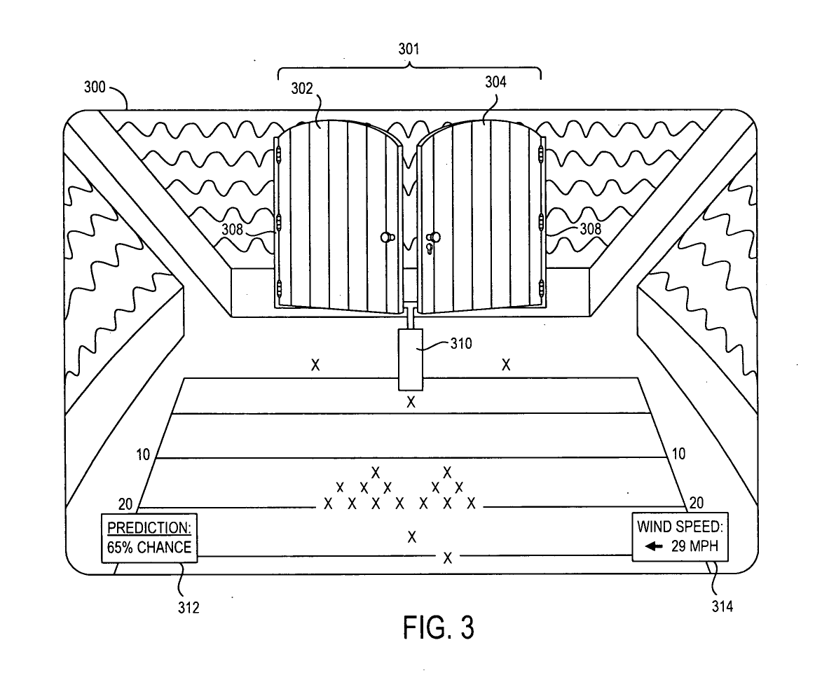

FIG. 3 is an example of a prediction graphic 301 that could be used as an overlay in association with the situation described above in “Update Example 1”. In particular, a selected prediction graphic 301 is overlaid on the broadcast of the football game shown on screen 300. The prediction graphic 301 includes a left door 302 that is graphically “hinged” to the left upright 306 of goalpost 310, and a right door 304 graphically hinged to the right upright 308 of the goalpost 310. The initial prediction described above, wherein it was determined that the kicker Mason Crosby was “Somewhat Unlikely” to successfully kick the field goal, is shown in FIG. 3 (the initial prediction and initial prediction graphic was determined in steps 1-3 of Example 1). As shown, the doors 302 and 304 are nearly closed, indicating the difficulty that the kicker Mason Crosby may have in successfully kicking the field goal. That is, the doors are slightly ajar to graphically indicate that the football is somewhat unlikely to make it through. In addition, an overlay 312 has been added to the bottom left portion of the screen 300 to display the determined initial prediction (here, a 65% chance of success). Telemetry data 314 has also been added, as shown in the bottom right portion of the screen 300, to indicate the current wind speed and direction (indicated by an arrow).

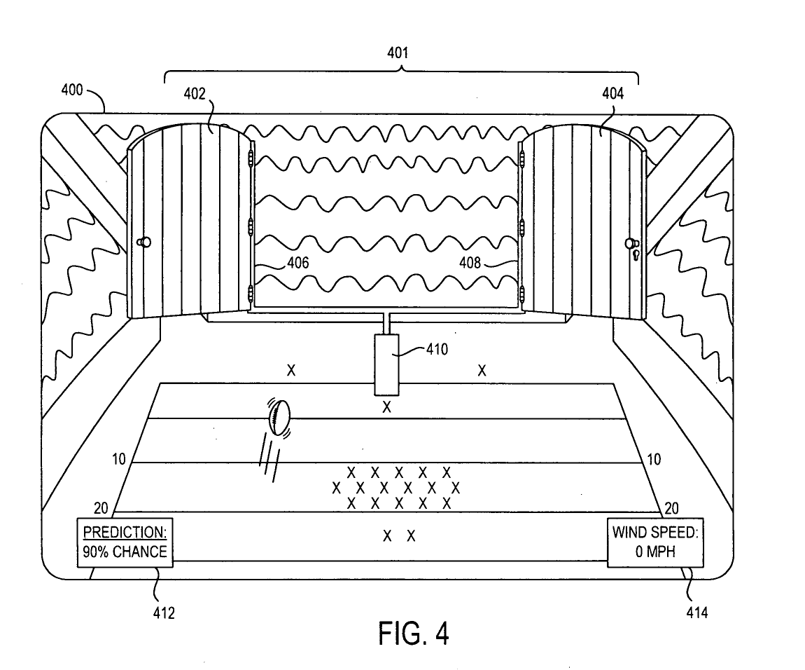

FIG. 4 shows an updated prediction graphic 401 on the screen 400 (an updated version of the graphic 301 of FIG. 3), which was determined in step 4 of “Update Example 1”, as explained above. In particular, the doors 402 and 404 of FIG. 4 have been opened wide to indicate the updated, favorable prediction (“Highly Likely”), based on the fact that wind has died down to zero (as shown in the telemetry data graphic 414 at the bottom right of the screen). This new wind speed data increased the chance of success to 90%, which is also shown in the overly 412 on the bottom left side of the screen 400.

It should be noted that the prediction graphic may or may not immediately change once an updated prediction has been produced. In some embodiments, the Prediction graphic may become animated when the updated prediction is determined. For instance, the doors may gradually swing open as the play progresses, and at the same time the Wind Speed overlay may decrement while the Prediction overlay is being changed. Each of the overlay portions shown on the screen during the broadcast may also be highlighted.

In some embodiments, animations may occur while the live action is switched into slow motion. Slow motion effects may emphasize the updated prediction, and provide time to perform attractive animations, as well as time to calculate new predictions or to configure new prediction graphics, if desired and/or necessary. Similarly, synthetic imagery may allow special effects to be inserted into, or even replace, the live footage. For example, a CGI generator may be used to create a simulated version of the live footage so that 3D effects may be applied. For example, a camera angle may continuously change while the prediction graphic animations are performed. More information regarding how Slow Motion effects and Synthetic Imagery may be applied to a live broadcast event can be found in commonly owned U.S. patent application Ser. No. 12/270,455, entitled “Methods and Systems for Broadcasting Modified Live Media”.

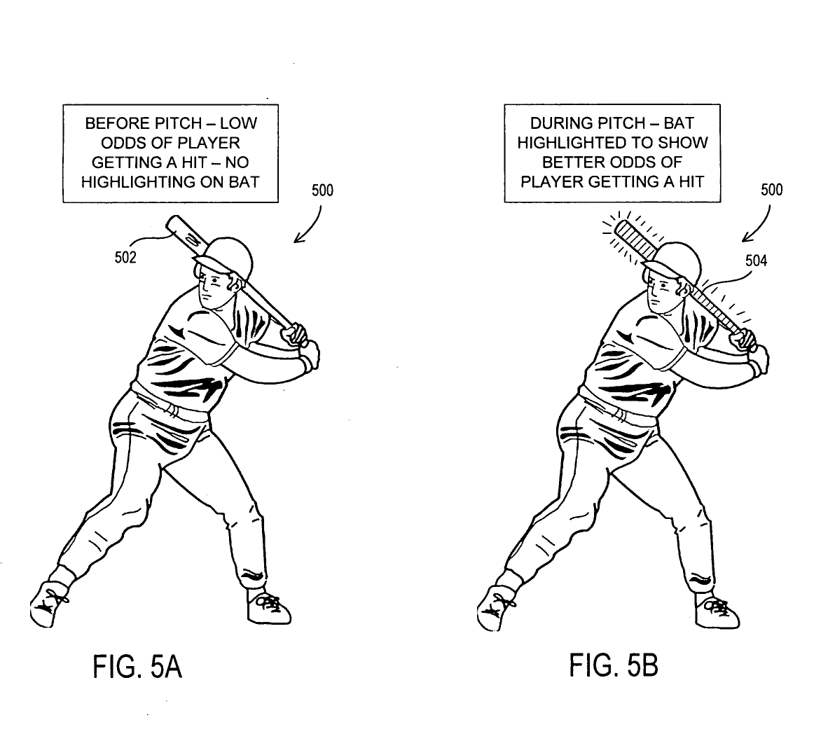

FIGS. 5A and 5B illustrate a different scenario in which a prediction graphic is selected and activated after a play has begun. FIG. 5A depicts a baseball batter 500 waiting for a pitch, wherein, a prediction has been determined prior to the pitch, based on historical data and/or other data, that the player has low odds of getting a hit. Thus, the prediction generator (or operator) does not initiate a prediction graphic and therefore the bat 502 of the batter appears as normally broadcast, without any change. However, while the play is in progress, a telemetric reading may be taken that causes an updated prediction to be produced. For example, an updated prediction gives the player 500 high odds of getting a hit (perhaps because the speed of the pitch is very slow) and thus a prediction graphic has been activated as shown in FIG. 5B so that the bat 504 is overlaid to glow a red color to indicate that a hit is likely. It should be noted that the prediction graphic used in FIG. 5B is more subtle than the prediction graphic used in FIGS. 3 and 4. In this case, the prediction graphic is a color overlay that is placed over the player's bat.

3.0 Rules of Interpretation

Numerous embodiments have been described and presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present methods and systems can be practiced with various modifications and alterations. Although particular features have been described with reference to one or more particular embodiments or figures that form a part of the present disclosure, and which show, by way of illustration, specific embodiments, it should be understood that such features are not limited to usage in the one or more particular embodiments or figures with reference to which they are described. The present disclosure is thus neither a literal description of all embodiments nor a listing of features that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise. The terms “including”, “comprising” and variations thereof mean “including but not limited to”, unless expressly specified otherwise.

The term “consisting of” and variations thereof mean “including and limited to”, unless expressly specified otherwise.

Any enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The term “comprising at least one of” followed by a listing of items does not imply that a component or subcomponent from each item in the list is required. Rather, it means that one or more of the items listed may comprise the item specified. For example, if it is said “wherein A comprises at least one of: a, b and c” it is meant that (i) A may comprise a, (ii) A may comprise b, (iii) A may comprise c, (iv) A may comprise a and b, (v) A may comprise a and c, (vi) A may comprise b and c, or (vii) A may comprise a, b and c.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this document and the title are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required, or that each of the disclosed components must communicate with every other component. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described in this document does not, in and of itself, indicate a requirement that the steps be performed in that order. The steps of processes described herein may be performed in any order that is practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

It will be readily apparent that the various methods and algorithms described herein may be implemented by, e.g., appropriately programmed general purpose computers and computing devices. Typically a processor (e.g., a microprocessor or controller device) will receive instructions from a computer readable media such as a memory or like storage device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media may include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Transmission Control Protocol, Internet Protocol (TCP/IP), Wi-Fi, Bluetooth, TDMA, CDMA, Wi-MAX and 3G.

Where databases are described, it will be understood by one of ordinary skill in the art that (i) alternative database structures to those described may be readily employed, and (ii) other memory structures besides databases may be readily employed. Any schematic illustrations and accompanying descriptions of any sample databases presented herein are illustrative arrangements for stored representations of information. Any number of other arrangements may be employed besides those suggested by the tables that are shown. Similarly, any illustrated entries of the databases represent exemplary information or data only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

It should also be understood that, to the extent that any term recited in the claims is referred to elsewhere in this document in a manner consistent with a single meaning, that is done for the sake of clarity only, and it is not intended that any such term be so restricted, by implication or otherwise, to that single meaning. Finally, unless a claim element is defined by reciting the word “means” and a function without reciting any structure, it is not intended that the scope of any claim element be interpreted based on the application of 35 U.S.C. §112, sixth paragraph.

Although the present invention has been described with respect to preferred embodiments thereof, those skilled in the art will note that various substitutions and modifications may be made to those embodiments described herein without departing from the spirit and scope of the present invention.

What is claimed is:

1. A method, comprising:
receiving, by a prediction graphic generator, at least one of telemetry data, situational data, or historical data;
determining, by the prediction graphic generator, a prediction based on at least two of the telemetry data, the situational data, or the historical data;
generating a prediction overlay based on the prediction;
outputting the prediction overlay to a broadcast computer;
combining, by the broadcast computer, the prediction overlay with a live broadcast to generate an enhanced broadcast; and
transmitting, by the broadcast computer, the enhanced broadcast.

2. The method of claim 1, further comprising:
receiving, by the prediction graphic generator, at least one of updated telemetry data or updated situational data;
generating an updated prediction based on at least one of the updated telemetry data or the updated situational data;
generating an updated prediction overlay based on the updated prediction;
outputting the updated prediction overlay to the broadcast computer;
combining, by the broadcast computer, the updated prediction overlay with a live broadcast to generate an updated enhanced broadcast; and
transmitting, by the broadcast computer, the updated enhanced broadcast.

3. The method of claim 1, in which determining the prediction comprises comparing the telemetry data with the historical data.

4. The method of claim 1, in which determining the prediction comprises:
using at least one of the telemetry data or the situational data to select historical data;
determining an outcome frequency based on the selected historical data; and
determining the prediction by comparing the outcome frequency to a threshold amount.

5. The method of claim 1, in which generating a prediction overlay based on the prediction comprises selecting a prediction overlay from a plurality of preconfigured prediction overlays.

6. The method of claim 1, in which combining the prediction overlay with the live broadcast comprises:
configuring a prediction graphic; and
applying the prediction graphic to the live broadcast during a broadcast delay.

7. The method of claim 6, wherein the prediction graphic comprises a representation of factors required for an outcome to occur.

8. The method of claim 1, wherein the situational data comprises at least one of venue data, data associated with a playing surface, environmental data, or spectator data.

9. The method of claim 1, wherein the telemetry data comprises at least one of velocity data, acceleration data, distance data, position data, relative motion data, lighting data, or audio data.

10. The method of claim 1, wherein the prediction overlay comprises at least one of text, numbers, figures, a pop-up, a color overlay, a symbol, an avatar, or a ghost image.

11. A computer readable medium storing instructions configured to direct a processor to:
receive at least one of telemetry data, situational data, or historical data;
determine a prediction based on at least two of the telemetry data, the situational data, or the historical data;
generate a prediction overlay based on the prediction;
output the prediction overlay;
receive at least one of updated telemetry data or updated situational data;
generate an updated prediction based on at least one of the updated telemetry data or the updated situational data;
generate an updated prediction overlay based on the updated prediction; and
output the updated prediction overlay.

12. The computer readable medium of claim 11, in which the instructions for determining the prediction comprises instructions configured to direct the processor to compare the telemetry data with the historical data.

13. The computer readable medium of claim 11, in which the instructions for determining the prediction comprises instructions configured to direct the processor to:
use at least one of the telemetry data or the situational data to select historical data;
determine an outcome frequency based on the selected historical data; and
determine the prediction by comparing the outcome frequency to a threshold amount.

14. The computer readable medium of claim 11, in which the instructions for generating the prediction overlay comprises instructions configured to direct the processor to select a prediction overlay from a plurality of preconfigured prediction overlays.

15. The computer readable medium of claim 11, in which the instructions for receiving the situational data comprises instructions configured to direct the processor to receive at least one of venue data, data associated with a playing surface, environmental data, or spectator data.

16. The computer readable medium of claim 11, in which the instructions for receiving the telemetry data comprises instructions configured to direct the processor to receive at least one of velocity data, acceleration data, distance data, position data, relative motion data, lighting data, or audio data.

17. The computer readable medium of claim 11, in which the instructions for generating the prediction overlay comprises instructions configured to direct the processor to generate at least one of text, numbers, figures, a pop-up, a color overlay, a symbol, an avatar, or a ghost image.

18. A system, comprising:
a telemetry device;
an historic outcome database; and
a prediction graphic generator comprising a processor and a memory, the prediction graphic generator configured to receive data from the telemetry device and to receive historical data from the historic outcome database, and wherein the memory includes instructions configured to direct the processor to:
receive the telemetry data and the historical data;
determine a prediction based on the telemetry data and the historical data;
generate a prediction overlay based on the prediction; and
output the prediction overlay.

19. The system of claim 18, further comprising a prediction graphic user interface operatively coupled to the prediction graphic generator, the graphic user interface configured to provide situational data to the prediction graphic generator for use in determining the prediction.

20. The system of claim 18, further comprising:
at least one recording device; and
a broadcast computer configured to receive data from the at least one recording device and from the prediction graphic generator, the broadcast computer comprising a processor and a broadcast computer memory, wherein the broadcast computer memory comprises instructions configured to direct the processor to:
receive a live media feed of real time occurrences of a live event and introduce a predetermined delay;
receive the prediction overlay from the prediction graphic generator;
Combine the delayed live media feed with the prediction overlay to generate an enhanced broadcast; and
Output the enhanced broadcast.

21. The system of claim 20, further comprising a broadcast mixing device operatively coupled to the at least one recording device and to the broadcast computer, the broadcast mixing device operable to combine at least two audio feeds, to combine at least two video feeds, or to combine an audio feed and a video feed, or to switch between an audio feed and a video feed.
